(19) United States
(12) Patent Application Publication
(10) Pub. No.: US 2020/0056073 A1
(43) Pub. Date: Feb. 20, 2020

(54) Intumescent Firestop Tape Construction

(71) Applicant: 3M INNOVATIVE PROPERTIES COMPANY, St. Paul, MN (US)

(72) Inventors: John C. Hulteen, Afton, MN (US); George W. Frost, Afton, MN (US); Richard J. Haffner, New Richmond, WI (US); Ernst L. Schmidt, Hager City, WI (US)

(21) Appl. No.: 16/342,577

(22) PCT Filed: Oct. 6, 2017
(86) PCT No.: PCT/US2017/055474

§ 371 Date: Apr. 17, 2019

Related U.S. Application Data
(60) Provisional application No. 62/409,596, filed on Oct. 18, 2016.

(51) Int. Cl. C09J 7/38; C09J 5/00; E04B 1/94; B29C 65/50

(52) U.S. Cl. CPC C09J 7/385; C09J 5/00; C09J 2433/00; B29C 65/5042; E04B 1/948

(57) ABSTRACT

Described herein is an adhesive article for fire protection along with methods of using the same. The adhesive article comprises a substrate having a first major surface; an intumescent material fixedly attached to a central portion of the first major surface; and an adhesive layer disposed at least along two opposing distal portions of the first major surface.

### TECHNICAL FIELD

An intumescent firestop tape construction is described along with a method of use.

### SUMMARY

Building codes for commercial structures (e.g., apartments, office buildings) generally require a passive fire protection system to contain and/or slow the spread of a fire. Fire-resistant materials such as walls and doors are used. However, there are openings between walls and floors, and even openings within the walls and floors, that must be sealed to contain and/or slow the spread of fire.

Traditionally, caulking, putty, or spray foam are used to seal the openings. However, these materials can be labor intensive to apply and the quality and appearance of the final seal is often dependent on the skill level of the person applying it. Thus, there is a desire to identify alternative fire protection materials that can be used to seal openings, which may allow advantages in ease of use, range of use, and/or aesthetics.

In one aspect, an adhesive article is provided, the adhesive article comprising:

a substrate having a first major surface;

an intumescent material fixedly attached to a central portion of the first major surface; and an adhesive layer disposed at least along two opposing distal portions of the first major surface.

In another aspect, a method of fire protecting an opening is provided, the method comprising: sealing the opening with the adhesive article comprising: (a) a substrate having a first major surface; (b) an intumescent material fixedly attached to a central portion of the first major surface, and (c) an adhesive layer disposed at least along two opposing distal portions of the first major surface. The intumescent material is positioned over the opening and the adhesive layer is used to fixedly attach the adhesive article to the perimeter of the opening.

In yet another aspect, a method of making a firestop system is provided comprising

(a) providing a construction assembly comprising a first major surface and an opposing second major surface and further comprising a first penetration which intersects the first major surface, the first major surface further comprises a first attachment area located about the perimeter of the penetration;
(b) obtaining an adhesive article comprising a substrate having a first major surface; an intumescent material fixedly attached to a central portion of the first major surface; and an adhesive layer disposed at least along two opposing distal portions of the first major surface;
(c) positioning the intumescent material over the first penetration; and then
(d) fixedly attaching the adhesive article to the first attachment area of the first major surface of the construction assembly to form a firestop system

In yet another aspect, a method of attaching a fire resistant joint system to a dynamic joint in a structure is provided. The dynamic joint including a first structural element having a first attachment area and a second structural element having a second attachment area, the first and second structural elements being moveable with respect to one another, the first and second attachment areas defining a space therebetween, the space having a fixed length and a width which varies from a minimum width to a maximum width as the structural elements move with respect to each other. The method for attaching comprising the step of:
fixedly attaching an adhesive article comprising a substrate having a first major surface; an intumescent material fixedly attached to a central portion of the first major surface; and an adhesive layer disposed at least along two opposing distal portions of the first major surface,
wherein the adhesive layer contacts the first attachment area and the second attachment area and the intumescent material is positioned over the space to form a fire-resistant joint system.

The above summary is not intended to describe each embodiment. The details of one or more embodiments of the invention are also set forth in the description below. Other features, objects, and advantages will be apparent from the description and from the claims.

### BRIEF DESCRIPTION OF THE DRAWINGS

The figures disclosed below are representative embodiments of the present disclosure and are not drawn to scale.

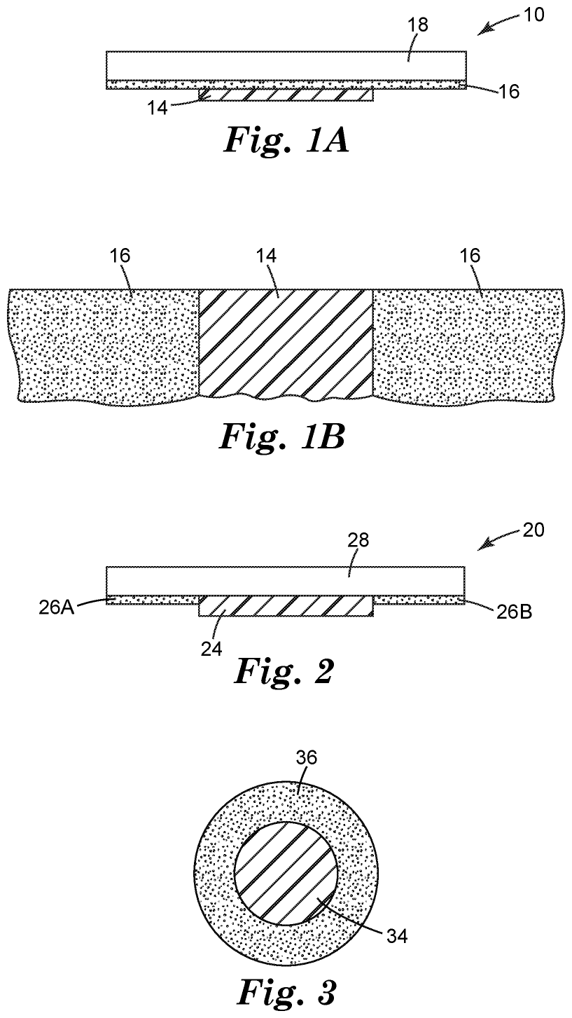

Shown in FIG. 1 is a schematic of a cross section (1A) and bottom view (1B) of one embodiment of an adhesive article of the present disclosure;

Shown in FIG. 2 is a schematic of a cross section of one embodiment of an adhesive article of the present disclosure;

Shown in FIG. 3 is a schematic of a bottom view of one embodiment of an adhesive article of the present disclosure;

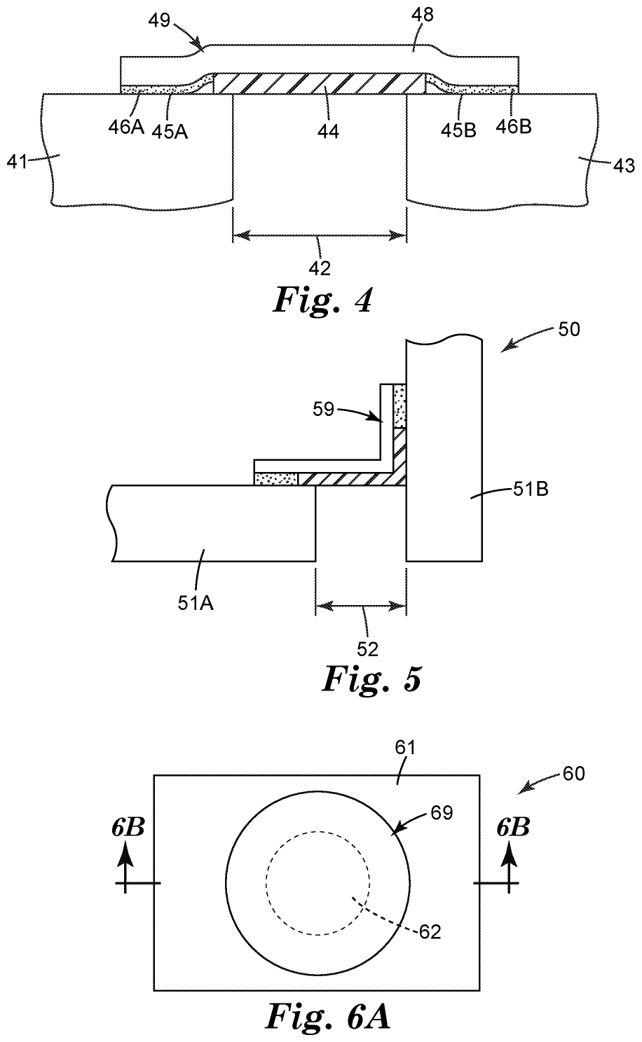

Shown in FIG. 4 is a side-view of one side of a wall comprising an exemplary joint system of a wall-to-wall joint disclosed herein;

Shown in FIG. 5 is a side-view of one side of a wall comprising an exemplary joint system of a 90 degree joint disclosed herein;

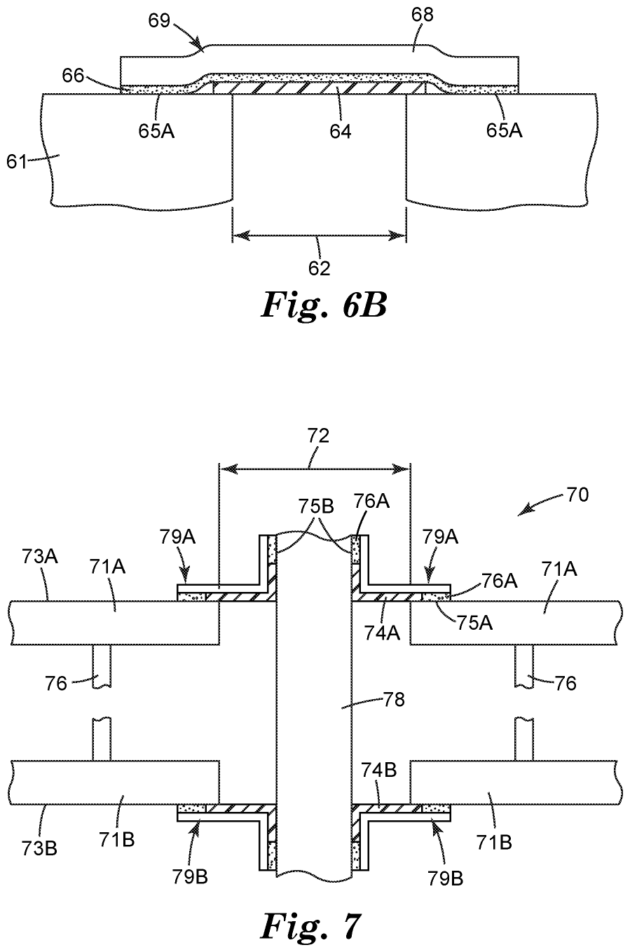

Shown in FIG. 6A is a top view and FIG. 6B is a side-view of one side of a firestop system disclosed herein; and

Shown in FIG. 7 is a side-view of a firestop system disclosed herein comprising a through penetration.

### DETAILED DESCRIPTION

As used herein, the term

“construction assembly” refers to a building construction such as a wall or floor comprising two opposing major surfaces wherein each major surfaces comprises a structural element;

“penetration” refers to an opening (or hole) which intersects a major surface of a construction assembly to allow for access to the interior of the construction assembly or to enable the passage of penetrating objects through the construction assembly;

“penetrating object” refers to a physical item that passes through the penetration and extends beyond the surface of the construction assembly. Such penetrating objects include cables, conduits, ducts, pipes, etc.);

“membrane penetration” refers to a penetration located on only one major surface of the construction assembly;

“through penetration” refers to construction assembly having a through hole wherein there are penetrations on both opposing major surfaces of the construction assembly;

“blank” refers to a penetration in a construction assembly that does not have a penetrating object;

“a”, “an”, and “the” are used interchangeably and mean one or more; and

“and/or” is used to indicate one or both stated cases may occur, for example A and/or B includes, (A and B) and (A or B).

Also herein, recitation of ranges by endpoints includes all numbers subsumed within that range (e.g., 1 to 10 includes 1.4, 1.9, 2.33, 5.75, 9.98, etc.).

Also herein, recitation of “at least one” includes all numbers of one and greater (e.g., at least 2, at least 4, at least 6, at least 8, at least 10, at least 25, at least 50, at least 100, etc.).

The present disclosure is directed toward the treatment of openings within buildings to contain and/or slow the spread of fire.

In one embodiment, openings such as joints, voids, gaps, or other discontinuities between two or more adjacent structural elements are present in buildings to accommodate building movements. Movements can occur between the adjacent structural elements, for example due to loads, heat, wind, and seismic events. These openings are sometimes referred to as dynamic joints, since they change (expand and contact or flex) over time. These openings are often between walls, between floors, or where a wall and floor (or ceiling) meet. A fire-resistant joint system can be achieved by applying the adhesive articles disclosed herein to a joint. As used herein, fire-resistant means that the joint system can, for a period of time, withstand the heat intensity (under conditions of a fire) and not structurally fail or allow the cold side of the joint to become hotter than a given temperature (e.g., about 200° C.).

Alternatively, in one embodiment, the opening is within a particular structural element (such as a wall or floor). Construction assemblies such as horizontal and vertical assemblies (e.g., floors, walls, and ceilings) have a required fire rating based on the construction materials and building code requirements. Sometimes openings are present in the walls, ceilings, and floors to allow for penetrating items (such as cables, pipes, ducts, conduits, etc.) through the building. Once an opening is made into the construction assembly, the fire-rating is compromised. The purpose of a firestop is to restore the fire-rating back to the original rating of the construction assembly.

Previously filed applications (U.S. Pat. Appl. Nos. 62/149,122 and 62/149,060 filed 17 Apr. 2015, herein incorporated by reference) disclosed packing an opening with a packing material and sealing the opening with a non-porous adhesive. It has been discovered that an intumescent material can be fixedly attached to the adhesive article, eliminating the need to pack the opening. Additionally, nominal openings between structural elements, such as static joints, can be treated, which can help contain and/or slow the spread of fires.

The adhesive article of present disclosure can be understood with respect to FIG. 1. Adhesive article 10 comprises adhesive layer 16 disposed on substrate 18. Intumescent material 14 is fixedly attached via adhesive layer 16.

The adhesive layer can be disposed continuously across the first major surface of the substrate as shown in FIG. 1A. Alternatively, the adhesive layer can be discontinuous across the substrate as shown in FIG. 2, wherein intumescent material 24 is fixedly attached to substrate 28 and positioned between adhesive layers 26A and 26B.

Intumescent Material

Intumescent materials are compositions that when exposed to heat or flames, expand typically at exposure temperatures above about 150° C. or even above about 200° C., producing an insulating and ablative char, which serves as a barrier to heat, smoke, and flames.

The intumescent materials of the present disclosure comprise an intumescent compound such as those known in the art, including silicates, expanding graphite, and vermiculite.

In one embodiment, the intumescent material is made from a coating comprising expanding graphite and a binder. Exemplary binders include epoxies, thermoplastic or latex resins. Exemplary thermoplastic or latex resins include polyvinyl chloride (PVC), polyurethane, polyester, polyvinyl acetate, phenolic resin or acrylic resin. In one embodiment, the intumescent material comprises at least 25, 30, 40, 50, 60, 70, 80, or even 90% by weight of expanding graphite.

In one embodiment, the intumescent material is made from a coating comprising at least four components: a source of mineral acid catalyst, typically ammonium polyphosphate; a source of carbon, typically pentaerythritol or dipentaerythritol; a blowing agent, typically melamine; and a binder, typically a thermoplastic resin (see above). When this intumescent material is subjected to heat, a series of reactions occur. The ammonium polyphosphate decomposes to produce polyphosphoric acid, catalyzing the dehydration of pentaerythritol to produce char. The blowing agent also starts to decompose, giving off non-flammable gases that cause the carbon char to foam, thus producing a meringue-like structure that is highly effective in insulating the substrate from heat. The basic function of the binder is to bind together the components of the intumescent coating, so that they may be applied to the substrate and held in intimate contact therewith until required to perform their function in a fire situation. Furthermore, the binder contributes to the formation of a uniform cellular foam structure, since the molten hinder helps trap the gases given off by the decomposing blowing agents, thus ensuring a controlled expansion of the char.

The thickness of the intumescent material can depend on the desired rating and the thermal resistance of the intumescent material as is known in the art. In one embodiment, the thickness of the intumescent material is at least 0.1, 0.125, 0.25, or even 0.5 inch (2.4, 3.1, 6.4, or even 12.7 mm); and at most 0.6, 0.75, 0.825, or even 1 inch (15, 19, 21, or even 25.4 mm). The intumescent materials of the present disclosure typically swell to 10-100 times their original thickness, producing an insulating char.

Substrate

The substrate of the adhesive article of the present disclosure may be selected from a polymeric film, a paper, a nonwoven matrix, a woven matrix, a metallic sheet, a foam, and combinations thereof. Exemplary substrates include polyolefins such as polyethylene, polypropylene (including isotactic polypropylene), polystyrene, polyester (such as poly(ethylene terephthalate) and poly(butylene terephthalate)), polyvinyl alcohol, poly(caprolactam), poly(vinylidene fluoride), polylactides, cellulose acetate, ethyl cellulose, and the like. Commercially available backing materials useful include Kraft paper (available from Monadnock Paper, Inc.); cellophane (available from Flexel Corp.); spun-bond poly(ethylene) and poly(propylene), available under the trade designation “TYVEK” and “TYPAR” (available from DuPont, Inc.); and films obtained from poly(ethylene) and poly(propylene), available under the trade designation “TESLIN” (available from PPG Industries, Inc.), and “CELLGUARD” (available from Hoechst-Celanese).

The substrate can be selected based on the application. The substrate should be stable (i.e., does not auto-ignite or distort) at temperatures of at least 80° C., 85° C., 90° C., 93° C., 95° C., 98° C., 100° C., 150° C., 180° C., or even 200° C. In one embodiment, the substrate has some flexibility allowing the adhesive article to absorb some of the movement (e.g., in a dynamic joint or between a structural element and a penetrating object) and/or the pressure experienced from a fire hose. In one embodiment, a polyolefin substrate is selected due to its resistance to humidity changes.

Adhesive Layer

An adhesive layer is disposed on the substrate as exemplified in FIGS. 1A and 2. Other layers as known in the adhesive art may be present, such as a primer layer located between the substrate and the adhesive and/or a coating (e.g., ink or low-adhesive backsizing) located on the second major surface of the substrate, opposite the adhesive layer, which is located on the first major surface of the substrate.

Adhesive materials useful in the present disclosure include those that allow adhesion to a variety of construction surfaces, including, for example, concrete, metal (e.g., aluminum or steel), and gypsum wallboard. Adhesive materials suitable for the practice of the present disclosure include polymers of silicones, acrylics, alpha olefins, ethylene/vinyl acetate, urethanes, and natural or synthetic rubbers. In one embodiment, the adhesive is a pressure sensitive adhesive.

Suitable urethane resins include polymers made from the reaction product of a compound containing at least two isocyanate groups (—N═C═O), referred to herein as “isocyanates”, and a compound containing at least two active-hydrogen containing groups. Examples of active-hydrogen containing groups include primary alcohols, secondary alcohols, phenols, and water. A wide variety of isocyanate-terminated materials and appropriate co-reactants are well known, and many are commercially available for example, polyurethane dispersion based PSA's from Dow Chemical Co. Also see, for example, Gunter Oertel, “Polyurethane Handbook”, Hanser Publishers, Munich (1985)).

In one embodiment, active-hydrogen compounds containing primary and secondary amines can react with an isocyanate to form a urea linkage, thereby forming a polyurea.

Suitable acrylic resins include acrylic pressure sensitive adhesives (PSAs). Acrylic PSAs comprise polymers of one or more (meth)acrylate ester monomers, which are monomeric (meth)acrylic esters of a non-tertiary alcohol, wherein the alcohol contains from 1 to 20 carbon atoms and preferably an average of from 4 to 14 carbon atoms.

Examples of monomers suitable for use as the (meth)acrylate ester monomer include the esters derived from either acrylic acid or methacrylic acid and non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isooctylalcohol, 2-ethyl-1-hexanol, 3,7-dimethylheptanol, 1-decanol, 1-dodecanol, 1-tridecanol, 1-tetradecanol, citronellol, dihydrocitronellol, and the like. In some embodiments, the preferred (meth)acrylate ester monomer is the ester of (meth)acrylic acid with butyl alcohol or isooctyl alcohol, or a combination thereof. In one embodiment, the (meth)acrylate ester monomer is present in an amount of 80 to 99 parts by weight based on 100 parts total monomer content used to prepare the polymer. Preferably (meth)acrylate ester monomer is present in an amount of 90 to 95 parts by weight based on 100 parts total monomer content.

The (meth)acrylic polymer further comprises a polar comonomer. For example, an acid group-containing comonomer. Examples of suitable acid-group containing monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, β-carboxyethyl (meth)acrylate, 2-sulfoethyl (meth)acrylate, styrene sulfonic acid, 2-acrylamido-2-methylpropanesulfonic acid, vinylphosphonic acid, and mixtures thereof.

Due to their availability, acid functional monomers of the acid functional copolymer are generally selected from ethylenically unsaturated carboxylic acids, i.e. (meth)acrylic acids. When even stronger acids are desired, acidic monomers include the ethylenically unsaturated sulfonic acids and ethylenically unsaturated phosphonic acids. In one embodiment, the acid functional monomer is generally used in amounts of 0 to 10 parts by weight, preferably 1 to 5 parts by weight, based on 100 parts by weight total monomer.

Other polar monomers may also be polymerized with (meth)acrylate ester monomer to form the polymer. Representative examples of other suitable polar monomers include, but are not limited to, 2-hydroxyethyl (meth)acrylate; N-vinylpyrrolidone; N-vinylcaprolactam; acrylamide; mono- or di-N-alkyl substituted acrylamides, such as for example t-butyl acrylamide, dimethylaminoethyl acrylamide, and N-octyl acrylamide; poly(alkoxyalkyl) (meth)acrylates including 2-(2-ethoxyethoxy)ethyl (meth)acrylate, 2-ethoxyethyl (meth)acrylate, 2-methoxyethoxyethyl (meth)acrylate, 2-methoxyethyl methacrylate, polyethylene glycol mono(meth)acrylates and mixtures thereof. Exemplary polar monomers include those selected from the group consisting of 2-hydroxyethyl (meth)acrylate and N-vinylpyrrolidone. In one embodiment, the other polar monomer may be present in amounts of 0 to 10 parts by weight, preferably 1 to 5 parts by weight, based on 100 parts by weight total monomer.

When used, vinyl monomers useful in the (meth)acrylate polymer include: alkyl vinyl ethers (e.g., vinyl methyl ether); vinyl esters (e.g., vinyl acetate and vinyl propionate), styrene, substituted styrene (e.g., α-methyl styrene), vinyl halide, and mixtures thereof. Such vinyl monomers are generally used at 0 to 5 parts by weight, preferably 1 to 5 parts by weight, based on 100 parts by weight total monomer.

In order to increase cohesive strength and improve the performance at elevated temperatures of the adhesive article, a multifunctional (meth)acrylate (comprising more than more acrylate group) may be incorporated into the blend of polymerizable monomers. Multifunctional acrylates are particularly useful for emulsion or syrup polymerization. Examples of useful multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof. The amount and identity of multifunctional (meth)acrylate is tailored depending upon application of the adhesive composition. Typically, the multifunctional (meth)acrylate is present in amounts less than 5 parts based on based on 100 parts by weight total monomer. In one embodiment, the multifunctional (meth)acrylate may be present in amounts from 0.01 parts to 1 part based on 100 parts total monomers of the adhesive composition.

Optional co-monomers can be used to tailor the performance of the PSA. Optional co-monomers include those having at least two different reactive groups e.g., 2-OH (meth) acrylate and glycidyl (meth)acrylate.

In one embodiment, the (meth)acrylic polymer can be crosslinked with thermal cross-linking agents, which are activated by heat, and/or photosensitive crosslinking agents, which are activated by ultraviolet (UV) light. Useful photosensitive cross-linking agents include: multifunctional (meth)acrylates, triazines, and combinations thereof. Exemplary crosslinking agents include substituted triazines such as 2,4,-bis(trichloromethyl)-6-(4-methoxy phenyl)-s-triazine, 2,4-bis(trichloromethyl)-6-(3,4-dimethoxyphenyl)-s-triazine, and the chromophore-substituted halo-s-triazines disclosed in U.S. Pat. Nos. 4,329,384 and 4,330,590 (Vesley). Various other crosslinking agents with different molecular weights between (meth)acrylate functionality may also be useful.

In one embodiment, glycidyl (meth)acrylate may be used as a thermal crosslinking agent to provide functionality which can be activated upon or after application in the field. For example, when the adhesive article is exposed to an elevated temperature, (e.g., a fire) the epoxy group of the glycidyl (meth)acrylate may react to provide further crosslinking, which can further increase the cohesive strength and increase the temperature resistance.

Suitable silicone resins include moisture-cured silicones, condensation-cured silicones, and addition-cured silicones, such as hydroxyl-terminated silicones, silicone rubber, and fluoro-silicone. Examples of suitable commercially available silicone PSA compositions comprising silicone resin include Dow Corning's 280A, 282, 7355, 7358, 7502, 7657, Q2-7406, Q2-7566 and Q2-7735; General Electric's PSA 590, PSA 600, PSA 595, PSA 610, PSA 518 (medium phenyl content), PSA 6574 (high phenyl content), PSA 529, PSA 750-D1, PSA 825-D1, and PSA 800-C. An example of two-part silicone resin commercially available is that sold under the trade designation “SILASTIC J” from Dow Chemical Company, Midland, Mich.

Pressure sensitive adhesives (PSAs) can include natural or synthetic rubbers such as styrene block copolymers (styrene-butadiene; styrene-isoprene; styrene-ethylene/butylene block copolymers); nitrile rubbers, synthetic polyisoprene, ethylene-propylene rubber, ethylene-propylene-diene monomer rubber (EPDM), polybutadiene, polyisobutylene, butyl rubber, styrene-butadiene random copolymers, and combinations thereof.

Additional pressure sensitive adhesive include poly(alpha-olefins), polychloroprene, and silicone elastomers. In some embodiments, polychloroprene and silicone elastomers may be preferred since polychloroprene contains a halogen, which can contribute towards flame resistance, and silicone elastomers are resistant to thermal degradation.

In one embodiment, the pressure sensitive adhesives may also contain one or more conventional additives. Preferred additives include tackifiers, plasticizers, foaming agents, dyes, antioxidants, and UV stabilizers.

In some embodiments, a tackifying agent may be required to provide the desired adhesive characteristics. Styrene block copolymers or (meth)acrylic polymers may include a suitable tackifying resin. Suitable tackifiers include rosin acids, rosin esters, terpene phenolic resins, hydrocarbon resins, and cumarone indene resins. The type and amount of tackifier can affect properties such as tack, bond strength, heat resistance, and specific adhesion. Exemplary tackifiers include: hydrogenated hydrocarbons available under the trade brands “REGALITE” and “REGALREZ”, by Eastman Chemical Co., Middelburg, Netherlands; and “ARKON” by Arakawa Chemical Inc., Chicago, Ill.; glycerin rosin ester available under the trade designation “FORAL 85” from Eastman Chemical Co., Kingsport, Tenn.; hydrocarbon or rosin types are available under the series “ESCOREZ” from ExxonMobil Chemical, Houston, Tex.; hydrocarbon resins available under the series trade designation “WINGTACK” from Cray Valley, Exton, Pa.; and terpene phenolic tackifiers available under the trade designation “SYLVARES TP96” from Arizona Chemical, Jacksonville, Fla.

In one embodiment, the pressure sensitive adhesive may contain a plasticizer, which can help soften the adhesive, and as a result, the structural element is more easily wetted by the adhesive. Further, the use of a plasticizer may improve the adhesive properties, including peel. The plasticizer may be hydrophobic and/or hydrophobic.

In one embodiment, the pressure sensitive adhesive is selected from at least one of an acrylic copolymer and a tackified styrene block copolymer.

The adhesive should have such properties that allow the adhesive article to move as necessary. For example, in one embodiment, dynamic joints fastened with the adhesive article must pass the tests for movement as described in ASTM E1399/E1399M-97 (2013) “Standard Test Method for Cyclic Movement and Measuring the Minimum and Maximum Joint Widths of Architectural Joint Systems”.

In one embodiment, the adhesive has a 90° peel strength according to ASTM D6252/6252M-98 (2011) at a strain rate of 12 inches/minute of at least 0.7, 0.8, 1, 1.5, or even 2 lb/in on the structural element such as gypsum wallboard and/or concrete. However, the acceptable peel strength can be dependent upon the overlap (or attachment area) of the adhesive article to the construction material. For example, with larger adhesive overlaps, lower peel strengths may be acceptable; whereas with smaller attachment overlaps, higher peel strengths may be necessary.

The adhesive is applied at a thickness sufficient to adhere the adhesive article to a building's structural elements. The thickness of the adhesive typically ranges from about 2 mil (50 micrometers) to about 30 mil (762 micrometers). A thick layer of adhesive material may be desirable for some applications, for example so that the adhesive material conforms to an irregular surface of the structural element (e.g., concrete). Preferably, the adhesive forms a layer with sufficient adhesion between the adhesive article and the structural element. The time required for the adhesion to develop may vary due to humidity and/or ambient temperature.

The adhesive article comprises an intumescent material fixedly attached to a central portion of the substrate with adhesive on both sides. In one embodiment, the adhesive is a continuous layer across the first major surface of the substrate as shown in FIG. 1A. In one embodiment, the adhesive is a discontinuous layer across the first major surface of the substrate as shown in FIG. 2, wherein the adhesive is located on the distal portions of the first major surface of the substrate and the intumescent material is located therebetween. Adhesive layer 26A and 26B may be the same composition or different.

The intumescent material is located on a central portion of the adhesive article. In one embodiment the central portion is at least 0.25, 0.5, 1, 2, 4, 6, 10, or even 12 inches (6.4, 12.7, 25.4, 50.8, 102, 152, 254, or even 305 mm) in width. Preferably, the intumescent material is centrally located along the axis of the adhesive article as shown in FIGS. 1B and 2, with adhesive layers located on either side of the intumescent material. The adhesive layers are used to affix the adhesive article to structural element(s). In one embodiment, the opposing distal portions of the adhesive layer are each at least 0.25, 0.5, 1, 2, 4, or even 6 inches (6.4, 12.7, 25.4, 50.8, 102, or even 152 mm) in width. In some embodiments, the intumescent material may not be centrally located, however, a sufficient amount of adhesive layer must be present of either side of the intumescent material to affix the adhesive article to structural element(s).

In one embodiment, the adhesive article can be used in a roll format, sheet, or a die cut shape. The adhesive article can be used with extended lengths, as shown in FIG. 1B, wherein the adhesive layer is disposed on two distal portions of the first major surface of the substrate with the intumescent material located on a central portion of the first major surface of the substrate. Such extended lengths of adhesive article of the present disclosure could be used, for example, to treat joints, and head-of-wall and wall-to-wall joints. In one embodiment, the extended lengths are at least 1, 5, 8, or even 10 meters. In one embodiment, the adhesive article may be provided in small pre-cut units, where the intumescent material is centrally-located on a portion of the adhesive article with adhesive framing (or surrounding) the intumescent material. For example, as shown in FIG. 3, intumescent material 34, is surrounded by adhesive layer 36. Such articles could be used to treat, for example, a penetration in a wall.

In one embodiment, the adhesive article of the present disclosure comprises a liner, which is removed from the adhesive side of the adhesive article prior to application to the structural element(s). A liner is a temporary support that is not intended for final use of the adhesive article and is used during the manufacture or storage to support and/or protect the adhesive article. A liner is removed from the adhesive article prior to use. Such liners are known in the art.

In the present disclosure, a liner may optionally be used opposite the substrate, with the adhesive sandwiched therebetween. Alternatively, the substrate may be coated with a release coating on its second major surface side opposite the adhesive layer.

To facilitate easy removal from the adhesive layer, the liner and release coating comprise a release agent. Such release agents are known in the art and are described, for example in “Handbook of Pressure Sensitive Adhesive Technology,” D. Satas, editor, Van Nostrand Reinhold, New York, N.Y., 1989, pp. 585-600. In one embodiment, the release agent migrate to the surface (on the liner or release coating) to provide the appropriate release properties.

Examples of release agents include carbamates, silicones and fluorocarbons. Preferred release agents are carbamates having relatively high softening points. Carbamates having long side chains have relatively high softening points and thus are particularly suitable in the present disclosure. A particularly preferred release agent for use in the present disclosure is polyvinyl octadecyl carbamate, available from Anderson Development Co. of Adrian, Mich., marketed as ESCOAT P20, and from Mayzo Inc. of Norcross, Ga., marketed in various grades as RA-95H, RA-95HS, RA-155 and RA-585S.

Illustrative examples of surface applied (i.e., topical) release agents include polyvinyl carbamates such as disclosed in U.S. Pat. No. 2,532,011 (Dahiquist et al.), reactive silicones, fluorochemical polymers, epoxysilicones such as are disclosed in U.S. Pat. No. 4,313,988 (Bany et al.) and U.S. Pat. No. 4,482,687 (Kessel et al.), polyorganosiloxane-polyurea block copolymers such as are disclosed in European Appln. No. 250,248 (Leir et al.), etc.

Use

The adhesive articles of the present disclosure are used to treat openings in structural elements of buildings to contain and/or slow the spread of fire.

Dynamic Joints

In one embodiment, the adhesive articles of the present disclosure are used to treat dynamic joints to form a fire-resistant joint system. The joint system comprises a first structural element having a first attachment area and a second structural element having a second attachment area, the first and second structural elements being moveable with respect to one another, the first and second attachment areas defining a space therebetween, the space having a fixed length and a width which varies from a minimum width to a maximum width as the structural elements move with respect to each other. The adhesive article of the present disclosure is positioned such that the intumescent material is placed over the space and the adhesive layer is fixedly attached to the first attachment area and the second attachment area.

FIG. 4 depicts an exemplary configuration of a joint system between two parallel elements of one side of a construction assembly (e.g., a wall). First structural element 41 and second structural element 43 have a space (i.e., opening) 42 therebetween. Intumescent material 44 is disposed over space 42. Adhesive article 49 is applied over space 42, wherein the adhesive article is fixedly attached via adhesive 46A and 46B to first attachment area 45A and second attachment area 45B.

Shown in FIG. 4 is an opening between two parallel structural elements (e.g., wall-to-wall or floor-to-floor), however, the opening can also occur between structural elements that are approximately at a ninety degree angle with respect to one another, such as joints between floor-to-wall or head-of-wall such as shown in FIG. 5. Joint system 50 comprises a joint formed by first structural element 51A, which is approximately at 90 degrees from second structural element 51B, forming space 52. Adhesive article 59, comprising intumescent material centrally located over space 52 is fixedly attached to both structural elements via adhesive.

Typically the structural elements are capable of moving independently of one another. Thus the size of space (e.g. 42) can vary as the first structural element flexes relative to the second structural element due to thermal changes, wind, seismic activity, etc. The space between the structural elements is often referred to as a linear opening, because the length of the opening is at least 10 times greater than the width of the opening. The width of the opening may vary from its nominal joint width (i.e., the specified or installation width) ranging from a minimum joint width to a maximum joint width. The nominal width of the joint can vary depending of where the joint is located, for example, in the interior or the perimeter of the construction, with the perimeter wall generally having a larger nominal width. In one embodiment, a nominal width is at least 0.125, 0.25, 0.5, 0.75, 0.825, or even 1 inch (3.1, 6.4, 12.7, 19, 21, or even 25.4 mm); and at most 2, 3, 4, or even 5 inches (50.8, 76.2, 101.6, or even 127 mm), having a compression/expansion of at least 1%, 2%, 5%, or even 7%; and at most 20%, 25%, 30%, 40%, 50%, or even 55% of the nominal width. For example, if the nominal width is 1 inch, a compression/expansion at 25% would be 0.75 inches in compression to 1.25 inches in expansion. In one embodiment, e.g., a perimeter wall, the nominal width is at least 2, 3, or even 5 inches (50.8, 76.2, or even 127 mm); and at most 8, 9, 10, or even 11 inches (203, 229, 254, or even 279 mm), having a compression/expansion of at least 1%, 2%, 5%, or even 7%; and at most 20%, 25%, 30%, 40%, 50%, 55%, or even 60% of the nominal width.

In one embodiment of the present disclosure, the joint system, comprising the joint assembly (e.g., first and second structural elements), and the adhesive article of the present disclosure is fire-resistant. Wherein fire-resistant means that the joint system can, for a period of time, withstand the heat intensity (under conditions of a fire) and not structurally fail or allow the cold side of the joint to become hotter than a given temperature (e.g., about 200° C.). In one embodiment, the joint system passes a fire-rating test such that the joint system meets the desired fire-rating. In one embodiment, the adhesive article of the present disclosure seals the opening and the seal is not compromised during the shifting of the first and second structural elements relative to one another.

The joints disclosed herein occur in building constructions, thus, the adhesive article of the present disclosure is fixedly attached to structural elements made of construction materials such as gypsum wallboard (i.e., sheetrock), metal (e.g., steel, aluminum), cement (e.g., Portland cement concrete), concrete, mortar, masonry (e.g., brick and cement blocks), wood, plastics, and combinations thereof.

In one embodiment, the fire-resistant joint system is a fire-rated joint system, which passes an approved regiment of testing. Such tests include: ASTM method E2307-15 “Standard Test Method for Determining Fire Resistance of Perimeter Fire Barriers Using Intermediate-Scale, Multi-story Test Apparatus”; ASTM method E1966-07 “Standard Test Method for Fire-Resistive Joint Systems”; and the UL (Underwriters Laboratory) standard 2079-2008 (R2012) “Standard for Safety Tests for Fire Resistance of Building Joint Systems”. UL 2079 is similar to ASTM E1966 having a fire endurance test as well as a hose stream test, but also includes optional tests for air leakage and water leakage. Other tests includes: CAN/ULC “Standard Method of Fire Tests of Firestop Systems”; EN1366-4:2006+A1:2010 “Fire Resistance Tests for Service Installations-Linear Joint Seals”; BS 476 Part 20 (1987): “Fire Tests on Building Materials and Structures”; AS 1530.4-2005 “Methods of Fire Tests on Building Materials, Components, and Structures Part 4: Fire Resistance Test of Elements of Construction”; and ISO 10295-2:2009 “Fire Tests for Building Elements and Components—Fire Testing of Service Installations—Part 2: Linear Joint (Gap) Seals”.

To pass an approved fire-resistant test, the joint systems of the present disclosure need to withstand a defined temperature profile (for example, exceeding temperatures greater than 700° C.) for a period of time (as described in the standards). In one embodiment, the joint systems of the present disclosure pass a flexibility test, wherein the joint system is expanded and contracted for a given number of cycles. In one embodiment, the joint systems of the present disclosure need to pass a hose stream test, wherein a stream of water at a given pressure and time (as described in the standards) is delivered onto the joint system after a fire endurance test. The joint system is then rated based on the outcome of the tests. For example, if there are no failures at 1 hour following the test methods, the joint system is then rated for 1-hour. In one embodiment, the fire-resistant joint system of the present disclosure withstands the approved regiment of testing for a period of at least 30 minutes, at least 1 hour, at least 2 hours, or even at least 4 hours.

As mentioned above, the UL standard 2079 also includes an optional air leakage test (ability of the system to withstand pressure differentials) and water leakage test (ability of the system to withstand intermittent water exposure, e.g., rain, standing water, spills, etc.), which can then result in an L rating and W rating, respectively.

In one embodiment, the systems of the present disclosure pass ASTM E1966-07, E2307-15, and/or UL 2079-2008. In one embodiment, the systems of the present disclosure also pass the optional air leakage test and/or the water leakage test of UL 2079-2008 (R2012).

Penetrations

In one embodiment, the adhesive articles of the present disclosure are used to treat penetrations (or openings) within construction assemblies to make a firestop. The construction assembly comprises a first major surface and an opposing second major surface and further comprises a first opening which intersects the first major surface. The first major surface further comprises a first attachment area located about the perimeter of the opening. The adhesive article of the present disclosure is positioned such that the intumescent material is placed over the opening and the adhesive layer is fixedly attached to the first attachment area.

In some embodiments, a penetrating object having a second attachment area passes through the first penetration and extends beyond the first major surface of the construction assembly. In these embodiments, the adhesive article of the present disclosure is positioned such that the intumescent material is placed over the opening and the adhesive layer is fixedly attached to the first attachment area and the second attachment area.

FIG. 6 depicts an exemplary configuration of a fire protection system of the present disclosure, where FIG. 6A is a top view and FIG. 6B is a side view of a blank. Firestop system 60 comprises structural element 61, which also comprises penetration 62 which extends through structural element 61. Adhesive article 69 is applied over penetration 62, wherein the adhesive article is fixedly attached via adhesive 66 to first attachment area 65A of the structural element and intumescent material 64 is disposed over penetration 62.

FIG. 7 depicts an exemplary configuration of a firestop system of the present disclosure. System 70 includes a construction assembly comprising structural elements 71A and 71B supported by stud 76 comprising through penetration 72. Through penetration 72 intersects first major surface 73A and opposing second major surface 73B. Penetrating object 78 passes through the construction assembly via penetration 72. Adhesive article 79A is applied such that intumescent material 74A and 74B is placed over penetration 72 around penetrating object 78. First major surface 73A comprises a first attachment area 75A around the perimeter of the penetration. Penetrating object 78 comprises a second attachment area 75B around its perimeter near the intersection of the penetration with first major surface 73A. Adhesive article 79A is fixedly attached via adhesive layer 76 to first attachment area 75A and second attachment area 75B, sealing the first major surface of the construction assembly. Similarly, adhesive article 79B is fixedly attached to second major surface 73B and penetrating object 78, sealing the second major surface of the construction assembly.

Depicted in FIGS. 6 and 7 are penetrations occurring along the face of a planar surface of a construction assembly, which encompass a majority of the penetrations in the construction industry. However, in one embodiment, a penetration can occur at the meeting of two structural elements that may be at an angle relative to each other, such as penetration in a floor-to-wall or head-of-wall.

When the system comprises a penetrating object, in one embodiment, the adhesive article can withstand the differential movement of the penetrating object relative to the construction assembly in non-fire conditions due to, for example, expanding and contracting of the penetrating object and shifting of the penetrating object relative to the construction assembly.

In one embodiment, the system comprising the construction assembly and the adhesive article of the present disclosure is fire-resistant. Wherein fire-resistant means that the system can, for a period of time, withstand the heat intensity (under conditions of a fire) and not structurally fail or allow the cold side of the structure to become hotter than a given temperature (e.g., about 200° C.). In one embodiment the firestop system of the present disclosure passes a fire-rating test such that the system meets the desired fire-rating. It is also an objective in the present disclosure that in one embodiment, the adhesive article seals the penetration and is the assembly comprises a penetrating object, the seal not be compromised during the shifting of the penetrating object and the construction assembly relative to one another during non-fire conditions.

The penetrations disclosed herein occur in building constructions, thus, the adhesive article of the present disclosure is fixedly attached to structural elements made of construction materials such as gypsum wallboard (i.e., sheetrock), metal (e.g., steel, aluminum), cement (e.g., Portland cement concrete), concrete, mortar, masonry (e.g., brick and cement blocks), wood, plastics, and combinations thereof.

These penetrations can occur at various locations and numbers along a construction assembly. The shape (circular, oblong, rectangular, etc.) and width of the opening can vary. In one embodiment, the length of the smallest dimension of the opening is at least 0.125, 0.25, 0.5, 0.75, 0.825, 1, 2, 3, 4, or even 5 inch (3.1, 6.4, 12.7, 19, 21, 25, 51, 76, 102, or even 127 mm); and at most 16, 48, or even 60 inches (406, 1219, or even 1524 mm). Typically, in the larger opening dimensions, a penetrating object is present and will consume a portion of the opening. Therefore, the amount of the penetration requiring sealing with the adhesive article will be a portion of the dimension of the penetration. For example, a wall comprising a 2 inch diameter circular opening with a 1.5 inch diameter pipe therethrough would require sealing of the opening in the wall around the perimeter of the pipe (about 0.25 inches around the outside of the pipe).

The penetrating objects can be made from a variety of materials commonly used in the construction industry including, for example, metal, glass, fiberglass, and plastic (including polyethylene, polypropylene, polyvinyl chloride, and fluorinated plastics such as polytetrafluoroethylene (PTFE)).

In one embodiment, the construction assembly comprising the adhesive article is a fire-rated system, which passes an approved regiment of testing. Such tests include: ASTM method E814-13a “Standard Test Method for Fire Tests of Penetration Firestop Systems and the UL (Underwriters Laboratory) standard 1479 (R2012) “Fire Tests of Through-Penetration Firestops”. UL 1479 is similar to ASTM E814 having a fire endurance test as well as a hose stream test, but also includes optional tests for air leakage and water leakage. Other tests include CAN/ULC-S115-11 “Standard Method of Fire Tests of FireStop Systems”; EN 1366-3:2009 “Fire Resistance Tests for Service Installations—Penetration Seals”; AS 1530.4-2005 “Methods of Fire Tests on Building Materials, Components and Structures Part 4: Fire Resistance Test of Elements of Construction”; ISO 834-11: 2014 “Fire Resistance Test—Elements of Building Construction-Part 11: Specific Requirements of the Assessment of Fire Protection to Structural Steel Elements”; BS 476 Fire Tests; and ISO 10295-1:2007 “Fire Tests for Building Elements and Components—Fire Testing of Service Installations—Part 1: Penetration Seals”.

To pass an approved fire test, the firestop systems of the present disclosure (comprising the construction assembly, the penetration, the adhesive article, and the penetrating object, if present) need to withstand a defined temperature profile (for example, exceeding temperatures greater than 700° C.) for a period of time (as described in the standards). In one embodiment, the systems of the present disclosure need to pass a hose stream test, wherein a stream of water at a given pressure and time (as described in the standards) is delivered onto the system after the fire endurance test. The system is then rated based on the outcome of the tests. For example, if there are no failures at 1 hour following the test methods, the system is then rated for 1-hour. In one embodiment, the fire-resistant system of the present disclosure withstands the approved regiment of testing for a period of at least 30 minutes, at least 1 hour, at least 2 hours, or even at least 4 hours.

According to ASTM E814 there are two ratings for a firestop system. An F rating is based on when a flame occurrence on the cold side of the wall (the surface away from the fire). A T rating is based on the temperature rise as well as the flame occurrence on the cold side of the wall. These rating are used, along with the presence and type of a penetrating object and the location of the opening, to evaluate the firestop system's performance.

As mentioned above, the UL standard 1479 also includes an optional air leakage test (ability of the assembly to withstand pressure differentials) and water leakage test (ability of the assembly to withstand intermittent water exposure, e.g., rain, standing water, spills, etc.), which can then result in an L rating and W rating, respectively.

In one embodiment, the assemblies of the present disclosure pass ASTM E814 and/or UL 1479. In one embodiment, the assemblies of the present disclosure also pass the optional air leakage test and/or the water leakage test of UL 1479.

In the present disclosure, the construction assembly can comprise a membrane penetration or a through penetration. As is known in the art and described in industry standard test methods, if the assembly has a symmetric through penetration only one side of the assembly is tested to determine the rating. However, if the assembly comprises a membrane penetration or an asymmetric through penetration, then each side (front and back) of the assembly is independently tested to ensure that the wall or floor is restored back it its original rating and/or meets the desired building requirements.

Other Openings

The adhesive articles of the present disclosure can be used to treat almost any opening in a building's construction besides the dynamic joints and penetrations described above. For example, the adhesive articles of the present disclosure may be used to treat the nominal space between two abutting gypsum boards, concrete block, or other wall, ceiling or floor construction materials.

The intumescent material is used as a thermal barrier to maintain the integrity of the substrate. The substrate seals the opening, keeps the intumescent material in position over the opening, and/or prevents the movement of the intumescent material upon expansion. The intumescent material should snugly fit, and more preferably overlap the opening. In one embodiment, the intumescent material is about the same width as the opening. In one embodiment, the intumescent material overlaps the opening by at least 0.25, 0.5, or even 0.75 inches (6.4, 12.7, or even 19 mm) on either side; and at most 1, or even 2 inches (25.4, or even 50.8 mm).

The adhesive layer should sufficiently overlap the structural elements to maintain contact with the structural elements and maintain a seal over the lifetime of the joint. In one embodiment, the adhesive overlaps the opening by at least 0.25, 0.5, 0.75, 1, 2, or even 4 inches (6.4, 12.7, 19, 25.4, 50.8, or even 101.6 mm) on either side; and at most 6 or even 12 inches (152.4, or even 304.8 mm). In other words, the adhesive contacts the first attachment area by at least 0.25 inches and the second attachment area by at least 0.25 inches. The acceptable overlap of the adhesive with the attachment areas can depend on the nature of the structural element (e.g., concrete versus gypsum); adhesive used (e.g., the 90 degree peel strength as mentioned above); and/or the flexibility of the substrate (e.g., more overlap needed for substrates that are not as flexible).

Heretofore the means for sealing such joints has been to insert an insulation batting or to spray foam, putty, or caulk into the joint gap. Using an adhesive article as disclosed herein for a fire protection article has advantages over the putties, caulks and spray coatings, including the ability to use over a broader working range (for example, at temperatures below 4° C. and in wet conditions) with little preparation of the structural elements, and ease of use (i.e., rolling a strip of tape down a wall wherein the adhesive is contained in the adhesive article).

The system of the present disclosure is rated for protection of the “cold side” of the structure (e.g., wall or floor). In other words, the side of the wall away from the fire. Since, one cannot predict which side of the wall a fire will occur, in practical use, the adhesive article of the present disclosure can be used on both openings of the wall as shown in FIG. 7. For example, during a fire on Side A, adhesive article 79A may burn or melt in the fire. Although not wanting to be limited by theory, it is believed that intumescent material 74A and 74B act as a thermal barrier helping to minimize the temperatures experienced by the substrate on the cold side of the wall. It is also believed that adhesive article 79B acts as a barrier minimizing a stack effect (i.e., movement of air resulting from pressure, and/or temperature differences). These stack effects can lead to potential spreading of combustion products (e.g., flame, and/or hot gases including smoke, and heat) from one area to another throughout the building.

It has been discovered that the adhesive articles of the present disclosure provide a fire-resistant system or even a fire-rated system, fire-rated for 30 minutes, 1 hour, 2 hours, or even 4 hours. This is surprising because as mentioned above, the fire-rated system must meet the fire test and water hose test. In dynamic applications, such as in dynamic joints and penetrating objects, the adhesive article must also have the ability to flex with movement (e.g., building or penetrating object) and have long term durability (e.g., 20 years, 30 years or even 40 years). Furthermore, construction sites are typically thought of as dirty, with dust, dirt, etc. In one embodiment, the adhesive articles disclosed herein can be applied to the structural elements without clean-up or priming of the structural elements. Still further, in one embodiment, the adhesive articles disclosed herein can be applied to water saturated structural elements such as cement concrete and still fixedly attach to the structural element.

Select embodiments of the present disclosure include, but are not limited to, the following:

### Embodiment 1

An adhesive article, the adhesive article comprising:
a substrate having a first major surface;
an intumescent material fixedly attached to a central portion of the first major surface; and
an adhesive layer disposed at least along two opposing distal portions of the first major surface.

### Embodiment 2

The adhesive article of embodiment 1, wherein the intumescent material is fixedly attached to the first major surface via the adhesive layer.

### Embodiment 3

The adhesive article of embodiment 1, wherein the at least two opposing distal portions of the adhesive layer are discontinuous across the width of the adhesive article.

### Embodiment 4

The adhesive article of any one of the previous embodiments, wherein the adhesive layer comprises at least one of an epoxy, an acrylic, a urethane, a silicone, and a rubber.

### Embodiment 5

The adhesive article of any one of the previous embodiments, wherein the adhesive layer is a pressure sensitive adhesive.

### Embodiment 6

The adhesive article of any one of the previous embodiments, wherein the adhesive layer comprises at least one of (i) an acrylic adhesive and (ii) a styrene block copolymer and a tackifier.

### Embodiment 7

The adhesive article of any one of the previous embodiments, wherein the substrate is selected from a polymeric film, a paper, a nonwoven matrix, a woven matrix, a metallic sheet, a foam, and combinations thereof.

### Embodiment 8

The adhesive article of any one of the previous embodiments, wherein the central portion is at least 12 mm wide.

### Embodiment 9

The adhesive article of any one of the previous embodiments, wherein the opposing distal portions are each at least 6 mm wide.

### Embodiment 10

The adhesive article of any one of the previous embodiments, wherein the adhesive article is an extended length.

### Embodiment 11

The adhesive article of embodiment 10, wherein the extended length is at least 5 meters.

### Embodiment 12

The adhesive article of any one of the previous embodiments, wherein the intumescent material is framed by an adhesive layer.

### Embodiment 13

The adhesive article of any one of the previous embodiments, further comprising a liner, wherein the liner is disposed on the adhesive layer opposite the substrate.

### Embodiment 14

The adhesive article of any one of the previous embodiments, wherein the substrate comprises a release coating on the second major surface of the substrate opposite the adhesive layer.

### Embodiment 15

A method of fire protecting an opening, the method comprising:
sealing the opening with the adhesive article of any one of embodiments 1-14, wherein intumescent material is positioned over the opening and the adhesive layer is used to fixedly attach the adhesive article to the perimeter of the opening.

### Embodiment 16

The method of embodiment 15, wherein the opening is a space between two structural elements.

### Embodiment 17

The method of embodiment 16, wherein the space between the two structural elements is less than 6 mm.

### Embodiment 18

The method of embodiment 17, wherein the space between the two structural elements is more than 12 mm.

### Embodiment 19

The method of embodiment 15, wherein the opening is a hole in a wall or floor.

### Embodiment 20

The method of embodiment 19, wherein the opening comprises a through penetration.

### Embodiment 21

The method of embodiment 20, wherein the through penetration is a duct, a pipe, or a conduit.

### Embodiment 22

A method of attaching a fire resistant joint system to a dynamic joint in a structure, the dynamic joint including a first structural element having a first attachment area and a second structural element having a second attachment area, the first and second structural elements being moveable with respect to one another, the first and second attachment areas defining a space therebetween, the space having a fixed length and a width which varies from a minimum width to a maximum width as the structural elements move with respect to each other, the method for attaching comprising the step of:
fixedly attaching an adhesive article comprising a substrate having a first major surface; an intumescent material fixedly attached to a central portion of the first major surface; and an adhesive layer disposed at least along two opposing distal portions of the first major surface,
wherein the adhesive layer contacts the first attachment area and the second attachment area and the intumescent material is positioned over the space to form a fire-resistant joint system.

### Embodiment 23

A method of making a firestop system comprising
(a) providing a construction assembly comprising a first major surface and an opposing second major surface and further comprising a first penetration which intersects the first major surface, the first major surface further comprises a first attachment area located about the perimeter of the penetration;
(b) obtaining an adhesive article comprising a substrate having a first major surface; an intumescent material fixedly attached to a central portion of the first major surface; and an adhesive layer disposed at least along two opposing distal portions of the first major surface;
(c) positioning the intumescent material over the first penetration; and then
(d) fixedly attaching the adhesive article to the first attachment area of the first major surface of the construction assembly to form a firestop system.

### Embodiment 24

The method of embodiment 23, wherein the construction assembly further comprises a penetrating object having a second attachment area, wherein the penetrating object passes through the first penetration and extends beyond the first major surface of the construction assembly, and sealing the first penetration by fixedly attaching the adhesive article to the first attachment area and the second attachment area.

### Embodiment 25

The method of any one of embodiments 23-24, wherein the second major surface of the construction assembly comprises a second penetration which intersects the second major surface of the construction assembly, the second major surface further comprises a third attachment area located about the perimeter of the second penetration; optionally, positioning the intumescent material over the second penetration; and sealing the second penetration by fixedly attaching the adhesive article to the third attachment area of the second major surface to form a firestop system.

### Embodiment 26

The method of embodiment 25, wherein the construction assembly further comprises a penetrating object having a fourth attachment area, wherein the penetrating object passes through the second penetration and extends beyond the second major surface of the construction assembly, and sealing the second penetration by fixedly attaching the adhesive article to the third attachment area and the fourth attachment area.

### Examples

Advantages and embodiments of this disclosure are further illustrated by the following examples, but the particular materials and amounts thereof recited in these examples, as well as other conditions and details, should not be construed to unduly limit this invention. In these examples, all percentages, proportions and ratios are by weight unless otherwise indicated.

All materials are commercially available or known to those skilled in the art unless otherwise stated or apparent.

The following abbreviations are used: cm=centimeter; in =inch; lb=pound; mm=millimeter; m=meter; and ft=foot.

Test Methods

Gypsum Wall Construction

A wall was constructed as a 2 hour fire-rated construction joint consisting of gypsum board/steel stud assembly constructed of the materials and in the manner described in the individual U400-Series Wall or Partition Design in the UL Fire Resistance Directory (2014) and included the following construction features: Wall framing consisted of steel channel studs. Steel studs were a minimum 3⅝ in. (92 mm) wide by 1¼ in. (32 mm) deep with a minimum 25 gauge steel channels. Steel stud spacing was a maximum of 24 in. (610 mm) on center. Two layers ⅝ in. (16 mm) thick gypsum wallboard, as specified in the individual U400-Series Design were used on each side of the wall.

Various sized wall constructions were made, wherein each wall was a box comprising steel studs along the 4 minor sides with a front surface of gypsum board and a back surface of gypsum board. Two sections of walls were aligned next to one another with a linear opening (at time of installation of joint system) of about 2 in (5.1 cm), unless stated otherwise. The assembly was placed into an external metal frame and secured during testing.

Concrete Floor Construction

A floor was constructed as a 2 hour fire-rated construction joint with a minimum 4½ in. (114.3 mm) thick steel-reinforced lightweight structural concrete. Two sections of the concrete slabs that were 16 in (40.6 cm) by 35 in (88.9 cm) were aligned next to one another with a linear opening (at time of installation of joint system) of about 1 in (2.5 cm). The assembly was placed into an external metal frame and secured during testing.

Fire Test 1

The construction was tested according to Underwriters Laboratory Inc., Standard for Safety UL 1479 “Fire Tests of Through-Penetration Firestops”. One side of the construction was exposed to fire at temperatures following UL 1479 for 2 hours.

Two of the primary results associated with the UL 1479 testing procedure are Flame (or F-Rating) and Temperature (or T-Rating).

Flame (F-Rating)—The firestop system was exposed to elevated temperatures (e.g., a controlled fire). The system was required to withstand the fire test for the rating period without permitting the passage of flame through penetration, or the occurrence of flaming on any element of the unexposed side. If any passage of flame or flaming is noted, this section of the testing fails.

Temperature (T-Rating)—While the firestop system was exposed to elevated temperatures, the installation achieved its T-Rating, defined as when the temperature on the cold side of the system exceeds 181° C. above ambient. For example, if ambient temperature was 23° C. and the temperature on the cold side of the wall exceeded 204° C., this would result in a T-Rating at that time it took the cold side to exceed 204° C. A rating was assigned to the firestop system based upon when the assembly fails the temperature requirements. If the system passed 204° C. after 2 hours, the firestop system was designated as having a 2 hour T-Rating. If the system passed 204° C. after 15 minutes, the firestop system was designated as having a 15 minute T-Rating.

Fire Test 2

Fire Test 2 was similar to Fire Test 1, except the system was only exposed to fire for 1 hour.

Materials Table

| Material | Description |
|---|---|
| Tape 398FR | A flame retardant tape comprising a glass cloth backing with a pressure |
| | sensitive acrylic adhesive available under the trade designation “3M |
| | GLASS CLOTH TAPE 398 FR” from 3M Co., St. Paul, MN |
| Tape 8067 | An acrylic pressure sensitive adhesive tape available under the trade |
| | designation “3M ALL-WEATHER FLASHING TAPE 8067” from 3M |
| | Co., with a tape thickness of (0.0099 in) 0.25 mm and a backing thickness |
| | of (0.005 in) 0.13 mm. |
| Wrap | Intumescent material, 2.5 in (64 mm) wide 8.2 ft (2.5 m) roll available |
| | under the trade designation “3M FIRE BARRIER TUCK-IN WRAP |
| | STRIP” from 3M Co., St. Paul, MN |
| Graphite | 3772 EXPANDABLE GRAPHITE available from Asbury Graphite |
| | Mills, Inc., Asbury, NJ |
| Tape 666 | A double sided pressure sensitive adhesive tape 0.0035 in (0.076 mm) |
| | thick available under the trade designation “SCOTCH PERMANMENT |
| | DOUBLE SIDED TAPE WITH LINER, 666” from 3M Co., St. Paul, |
| | MN |

Preparation of Intumescent Film

Six parts Graphite and 4 parts of an aqueous vinyl acetate polymer dispersion were homogeneously mixed. The mixture was knife coated onto a release liner (a poly coated Kraft paper with a silicone release layer) to a thickness of 0.25 in (6.4 mm) and allowed to dry for 2 weeks. The Intumescent Film was removed from the release liner and cut into strips for use.

### Examples

### Comparative Example 1: Fire Retardant Tape

A wall was made following the Gypsum Wall Construction above. A wall assembly was constructed with two walls (16 in (406 mm) by 35 in (889 mm)) having a 2 inch (51 mm) width by 35 in (889 mm) linear opening therebetween. A flame retardant tape, Tape 398 FR, was placed over the entire length of the linear opening on both sides of the wall assembly, overlapping the gypsum wallboard by a minimum of 3.81 cm (1.5 in) on each side of the opening.

The system was tested following Fire Test 1. The system failed the Temperature and Flame tests.

### Example 1: Firestop Tape

A wall was made following the Gypsum Wall Construction above. A wall assembly was constructed with two walls (16 in (406 mm) by 35 in (889 mm)) having a 1 inch (25.4 mm) width by 35 in (889 mm) linear opening therebetween. A 1 inch (25.4 mm) width piece of Wrap was attached to the adhesive side of a 4 in wide strip of Tape 8067, roughly down the center of the tape. This intumescent tape construction was placed over the linear opening, overlapping the gypsum wall board by 1.5 in (38 mm) on each side of the opening and down the entire length of the opening. This intumescent tape construction was placed only on the cold side of the floor (the side that was to be away from the fire).

The system was tested following Fire Test 1 for Flame and Temperature and passed each of these tests.

### Example 2: Firestop Tape

A wall was made following the Gypsum Wall Construction above. A wall assembly was constructed with two walls (16 in (406 mm) by 35 in (889 mm)) having a 1 inch (25.4 mm) width by 35 in (889 mm) linear opening therebetween. A 1.5 in strip of Intumescent Film (above) was attached to the adhesive side of a 4 in wide strip of Tape 8067. This intumescent tape construction was placed over the linear opening, overlapping the gypsum wall board by 1.5 in (38 mm) on each side of the opening and down the entire length of the opening. This intumescent tape construction was placed only on the cold side of the floor (the side that was to be away from the fire).

The system was tested following Fire Test 2 for Flame and Temperature and passed each of these tests.

### Example 3: Firestop Tape

Floors were made following the Concrete Floor Construction described above. A floor assembly was constructed with two floors (16 in (406 mm) by 35 in (889 mm)) having a 1 inch (25.4 mm) width by 35 inch (889 mm) length linear opening therebetween. A 1.5 in strip of Intumescent Film was attached to the adhesive side of a 4 in (102 mm) wide strip of Tape 8067. This intumescent tape construction was placed over the linear opening, overlapping the concrete by 1.5 in (38 mm) on each side of the opening and down the entire length of the opening. This intumescent tape construction was placed only on the cold side of the floor (the side that was to be away from the fire).

The system was tested following Fire Test 2 for Flame and Temperature and passed each of these tests.

Comparative Example 2 (CE2)

Floors were made following the Concrete Floor Construction described above. A floor assembly was constructed with two floors (16 in (406 mm) by 35 in (889 mm)) having a 1 inch (25.4 mm) width by 35 inch (889 mm) length linear opening therebetween. Tape 666 was used to attached a 1.5 in (25.4 mm) wide by 35 inch (889 mm) long strip of Intumescent Film to the inside of the linear opening. The Intumescent Film with the double-sided tape attached was positioned approximately 1.25 in (31.8 mm) from the face of the floor and down the entire length of the linear opening. The system was tested following Fire Test 2 for Flame and Temperature and passed each of these tests.

The systems tested and the specific results from Fire Test are described in the Table 1 below

TABLE 1

| Sample | T-Rating (min) | Flame |
|---|---|---|
| CE1 | <15 | Fail in <15 min |
| E1 | 120 | Pass at 2 hr |
| E2 | 45 | Pass at 1 hr |
| E3 | 58 | Pass at 1 hr |
| CE2 | <15 | Fail in <15 min |

Foreseeable modifications and alterations of this invention will be apparent to those skilled in the art without departing from the scope and spirit of this invention. This invention should not be restricted to the embodiments that are set forth in this application for illustrative purposes.

1. An adhesive article, the adhesive article comprising:
a substrate having a first major surface;
an adhesive layer disposed continuously across the first major surface; and
an intumescent material fixedly attached to a central portion of the first major surface via the adhesive layer such that adhesive from the adhesive layer is not covered by the intumescent material
along at least two opposing distal portions of the first major surface.

2. (canceled)

3. (canceled)

4. The adhesive article of claim 1, wherein the adhesive layer comprises at least one of an epoxy, an acrylic, a urethane, a silicone, and a rubber.

5. The adhesive article of claim 1, wherein the adhesive layer comprises at least one of (i) an acrylic adhesive and (ii) a styrene block copolymer and a tackifier.

6. The adhesive article of claim 1, wherein the central portion is at least 12 mm wide.

7. The adhesive article of claim 1, wherein the opposing distal portions are each at least 12 mm wide.

8. The adhesive article of claim 1, wherein the adhesive article is an extended length.

9. The adhesive article of claim 1, wherein the intumescent material is framed by an adhesive layer.

10. A method of fire protecting an opening, the method comprising: sealing the opening with the adhesive article of claim 1, wherein intumescent material is positioned over the opening and the distal portions including the adhesive layer are used to fixedly attach the adhesive article to the perimeter of the opening.

11. The method of claim 10, wherein the opening is dynamic joint.

12. The method of claim 10, wherein the opening is a in a wall or floor, and wherein the opening comprises a through penetration.

13. (canceled)

14. A method of attaching a fire resistant joint system to a dynamic joint in a structure, the dynamic joint including a first structural element having a first attachment area and a second structural element having a second attachment area, the first and second structural elements being moveable with respect to one another, the first and second attachment areas defining a space therebetween, the space having a fixed length and a width which varies from a minimum width to a maximum width as the structural elements move with respect to each other, the method for attaching comprising the step of:
fixedly attaching an adhesive article according to claim 1,
wherein the adhesive layer contacts the first attachment area and the second attachment area and the intumescent material is positioned over the space to form a fire-resistant joint system.

15. (canceled)

16. The fire-resistant joint system of claim 14, wherein the first structural element is selected from at least one of cement, gypsum, wood, metal, and plastic.

17. The fire-resistant joint system of claim 14, wherein the second structural element is selected from at least one of cement, gypsum, wood, metal, and plastic.

18. The fire-resistant joint system of claim 14, wherein the fire-rated joint system passes at least one of ASTM E-1966-07 and UL 2079.
